(19) United States
(12) Patent Application Publication
(10) Pub. No.: US 2011/0316505 A1
(43) Pub. Date: Dec. 29, 2011

(54) Output Buffer With Improved Output Signal Quality

(75) Inventor: Aatmesh Shrivastava, Muzaffarpur (IN)

(73) Assignee: TEXAS INSTRUMENTS INCORPORATED, Dallas, TX (US)

(21) Appl. No.: 12/821,168

(22) Filed: Jun. 23, 2010

(51) Int. Cl. G05F 1/10

(52) U.S. Cl. 323/282

(57) ABSTRACT

An output buffer receives an input signal and generates an output signal at an output node. The output buffer contains a driver circuit. The driver circuit includes two pairs of cascoded transistors connected at a junction node. Each of the cascoded pairs receives a corresponding level-shifted signal representing the input signal, and generates corresponding driver signals on driver nodes which are coupled to the output node. The driver circuit includes a capacitor connected between one of the driver nodes and the junction node. The capacitor enables the corresponding driver signal to be generated to reach a desired voltage quickly. The output impedance of the output buffer with which the output signal is launched is reduced and more closely matched the impedance of the path on which the output signal is provided. Signal quality of the output signal is thereby improved.

### BACKGROUND

1. Technical Field

Embodiments of the present disclosure relate generally to integrated circuits (IC), and more specifically to an output buffer with improved output signal quality.

2. Related Art

An output buffer is generally a circuit that receives an input signal (often in digital form), and provides a corresponding output signal with increased drive (lower output impedance, and therefore ability to drive larger values of loads). Typically, in an IC, the output signal is provided on a pad/pin of the IC. For example, a data signal generated internally within a processor unit (e.g., central processing unit) is typically provided to an output buffer, which in turn generates a corresponding output signal at an output pin or pad of the IC.

Output signal quality of an output buffer generally refers to the characteristics of an output signal generated by the output buffer. Such characteristics include signal shape, slew-rate (signal rise and fall times), the impedance with which the output signal is generated (or launched) and the extent of signal distortion due to reflections arising from impedance mismatch, etc. An output buffer generally needs to generate an output signal consistent with a desired signal quality. For example, the slew-rate may need to be high (short rise and fall times), the impedance with which signal is launched may need to match the impedance of the wired path (e.g., printed circuit board (PCB) trace) connected to the output pin of the IC) to minimize signal reflections. An output buffer may need to support such output signal characteristics, while also meeting other requirements such as, for example, high reliability and smaller implementation area.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

A driver circuit in an output buffer includes a first pair of transistors formed of a first transistor and a second transistor coupled in cascode configuration, the first transistor to receive a first level-shifted signal, the first pair of transistors to generate a first driver signal as a logic inverse of the first level-shifted signal on a first driver node. The driver circuit includes a second pair of transistors formed of a third transistor and a fourth transistor coupled in cascode configuration, the fourth transistor to receive a second level-shifted signal, the second pair of transistors to generate a second driver signal as a logic inverse of the second level-shifted signal on a second driver node. The second pair of transistors is connected to the first pair of transistors at a junction node, the combination of the first pair of transistors and the second pair of transistors forming a cascoded inverter. The driver circuit includes a capacitor coupled across the first driver node and the junction node in parallel with the second transistor. Each of the first level-shifted signal and the second level-shifted signal represents a logic level of an input signal received by the output buffer. The first driver signal and the second driver signal are each coupled to an output node of the output buffer at which an output signal of the output buffer is generated, the output signal representing the input signal with an increased drive. The capacitor provides a low-impedance path for the first driver signal to change from a value representing one logic level to a value representing another logic level in a time interval shorter than a bit-period of the output signal.

Several embodiments of the present disclosure are described below with reference to examples for illustration. It should be understood that numerous specific details, relationships, and methods are set forth to provide a full understanding of the embodiments. One skilled in the relevant art, however, will readily recognize that the techniques can be practiced without one or more of the specific details, or with other methods, etc.

### BRIEF DESCRIPTION OF THE VIEWS OF DRAWINGS

FIG. 1 is a block diagram of an example environment in which several embodiments can be implemented.

FIG. 2 is a diagram illustrating the implementation details of an output buffer in an embodiment.

FIG. 3 is a diagram showing a portion of an output buffer in an embodiment.

FIG. 4 is a diagram used to illustrate the effect of a capacitor used in a driver circuit on output signal quality.

FIG. 5 is a diagram showing waveforms at nodes of a driver circuit implemented according to a prior technique.

FIG. 6 is a diagram showing waveforms at nodes of a driver circuit in an embodiment.

FIG. 7 is a block diagram of an example system in which embodiments of the present disclosure can be implemented.

The drawing in which an element first appears is indicated by the leftmost digit(s) in the corresponding reference number.

### DETAILED DESCRIPTION

Various embodiments are described below with several examples for illustration.

### 1. Example Environment

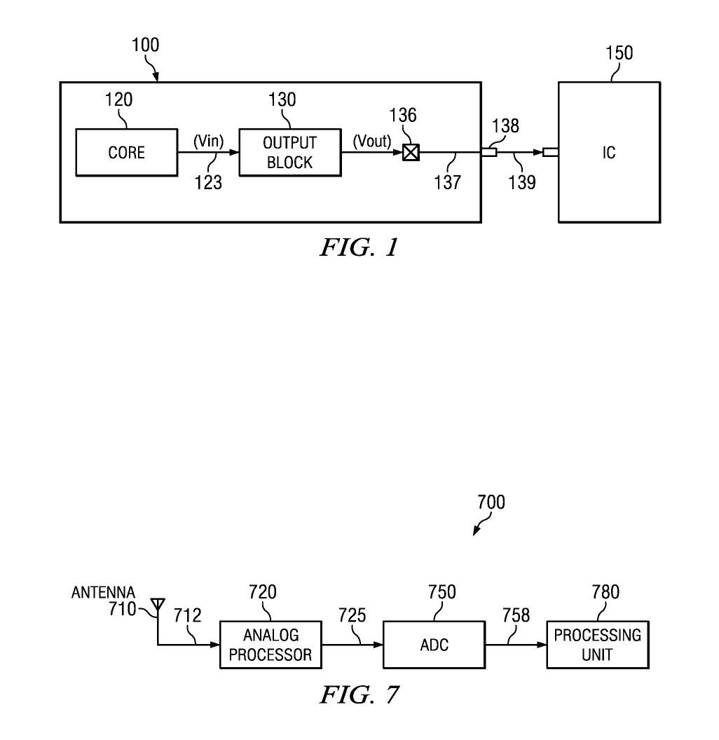

FIG. 1 is a block diagram illustrating an example environment in which several embodiments can be implemented. The diagram is shown containing integrated circuit (IC) 100 and IC 150. IC 100 is shown containing core 120 and output buffer 130.

Core 120 may correspond to a circuit portion generating digital signals (e.g., a central processing unit), and is shown providing an output digital binary signal 123 (Vin) to output buffer 130. Output buffer 130 processes Vin (123) to generate a buffered output on pad 136 (Vout) of IC 100. Output signal 136 is shown provided on pin 138 of IC 100. Pin 138 may be connected to an input pin of IC 150 through a corresponding trace (139) on a printed circuit board (PCB). Path 137 represents a bond wire in IC 100, connecting pad 136 to pin 138.

In an embodiment, circuits in core 120 are powered using a smaller value of power supply voltage (e.g., 1.2V) than circuits in output buffer 130. Assuming the power supply voltage is 1.2V, signal 123 (Vin) has a voltage swing between 0V and 1.2V in representing logic zero and logic one. Output buffer 130 receives the lower-swing signal 123 (Vin) and generates output signal 136 (Vout) with a larger voltage swing (e.g., 0V-3.3V). Drivers in output buffer 130 are designed to ensure generation of output signal 136 with improved output signal quality. In an embodiment, output signal 136 is generated consistent with corresponding standards such as LVCMOS specified by JEDEC (Joint Electronic Devices Engineering Council).

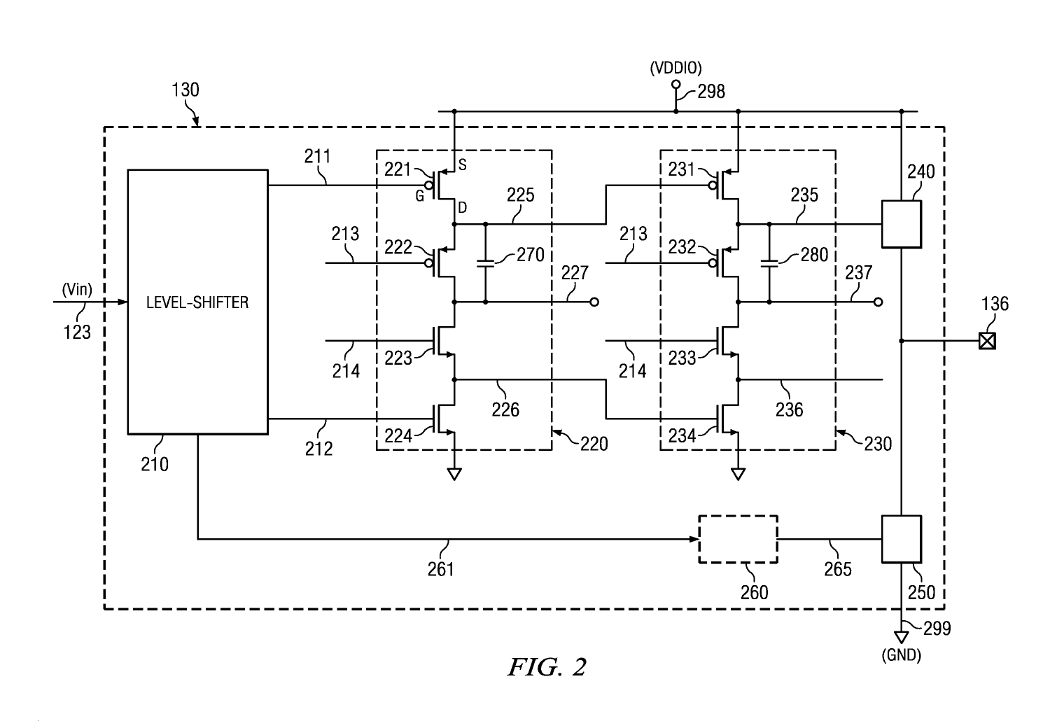

FIG. 2 is a diagram illustrating the implementation details of an output buffer in an embodiment. Output buffer 130 is shown containing level-shifter 210, drivers 220 and 230, pull-up circuit 240, pull-down circuit 250, and block 260. 298 (VDDIO) represents a power supply terminal (3.3V in an embodiment) used for powering circuits in output buffer 130. 299 (GND) represents a ground terminal (0V). It should be appreciated that the specific voltage values of power supplies as well as other signals/nodes in output buffer 130 are provided herein merely by way of example. Embodiments of the present disclosure may be implemented with other combinations of voltage levels as well, as will be apparent to one skilled in the relevant arts by reading the disclosure provided herein. Gate, source and drain terminals of transistor 221 are respectively marked G, S and D. The terminals of other transistors are not marked in FIG. 2, but can be identified from the symbol/notation used. Pull-up circuit 240 in combination with pull-down circuit 250 is referred to herein as an output stage. Drivers 220 and 230 are identical in structure and interconnections, and one is thus a replica of the other. However, the size of transistors used in driver 220 may be different from those used in driver 230. For example, the transistors of driver 230 may be larger in size (compared to those in driver 220) to be able to drive larger loads.

Level-shifter 210 receives input signal 123 (Vin), and generates level-shifted signals 211 and 212, each representing the logic level of signal 123. In an embodiment, when signal 123 has a value of 0V (representing logic zero), level shifter 210 generates signals 211 and 212 with values of (0.5*VDDIO) volts and zero volts (GND) respectively. When signal 123 has a value of 1.2V (representing logic one), level shifter 210 generates signals 211 and 212 with values of VDDIO and (0.5*VDDIO) respectively.

Driver circuit (driver) 220 is shown containing P-type MOS (metal oxide semiconductor) transistor (PMOS) 221 and 222, N-type MOS transistor (NMOS) 223 and 224, and capacitor 270. The combination of transistors 221 and 222 forms a cascode structure. As is well-known in the relevant arts, a cascode structure or configuration generally refers to an interconnection structure containing a transistor in common-emitter (or common-source) configuration followed by a transistor in common-base (or common-gate) configuration. The combination of transistors 224 and 223 also forms a cascode structure. The two cascode structures are connected at junction node 227. Driver circuit 220 represents a cascoded inverter.

Driver 230 is shown containing PMOS 231 and 232, and NMOS 233 and 234 and capacitor 280. The combination of transistors 231 and 232 (first pair of transistors), as well as the combination of transistors 233 and 234 (second pair of transistors) are also cascode structures, with the two cascode structures connected at junction node 237. Driver circuit 230 also represents a cascoded inverter.

The gate terminals 213 and 214 of transistors 222 and 223 respectively (and also of transistors 232 and 233 respectively) receive corresponding bias voltages. The bias voltages may be generated by a voltage reference component contained within output buffer 130, but not shown in FIG. 2. In an embodiment, the bias voltages provided on paths 213 and 214 approximately equal 0.5*VDDIO. However, the specific voltage level of the bias voltages may be chosen based on considerations such as reliability and signal quality of output signal 136.

Capacitor 270 of driver 220 is connected between paths/nodes 225 and 227, i.e., across transistor 222. Capacitor 280 of driver 230 is connected across transistor 232 (i.e., between paths/nodes 235 and 237). The provision of capacitors 270 and 280 enables output buffer 130 to provide output signal 136 with a desired signal quality, as described in detail below.

Each of the transistors in drivers 220 and 230 may be constructed using low-voltage processes, i.e. fabrication processes which specify lower maximum-safe-operation voltages (e.g., 1.8V or 1.2V) between transistor terminals, such as gate and source. The specific circuit structure formed by the interconnection of transistors in each of drivers 220 and 230 is designed to ensure that none of the transistors is subjected to voltage stresses beyond a safe limit specified by the low-voltage process according to which the transistors are implemented, and thereby to enable reliable use of transistors fabricated using such low-voltage technologies when providing a relatively higher-swing (e.g., 0V-3.3V) output signal at node 136.

Signals on paths (or driver nodes) 225 (first level-shifted signal) and 226 (second level-shifted signal) are referred to herein as driver signals, and respectively are the logic inverse of signals 211 and 212. Driver signals 225 and 226 are respectively provided to the gate terminals of transistors 231 and 234 of driver 230. Similarly, signals on paths (or driver nodes) 235 (first driver signal) and 236 (second driver signal) are also referred to herein as driver signals, and respectively are the logic inverse of signals 225 and 226. Driver signal 235 of driver 230 is connected to, and controls the ON/OFF state of, pull-up circuit 240. Signals 225 and 235 are assumed to transition between voltage levels VDDIO (representing logic one) and 0.5*VDDIO (representing logic zero). Signals 226 and 236 are assumed to transition between voltage levels 0.5*VDDIO (representing logic one) and GND (representing logic zero).

Block 260 represents one or more driver circuits used to drive pull-down circuit 250. Block 260 receives level-shifted signals on path 261 from level-shifter 210. In response, block 260 generates driver signal 265 which is connected to, and controls the ON/OFF state of, pull-down circuit 250. Output signal 136 (Vout) is provided at the junction of circuits 240 and 250, as shown in FIG. 2.

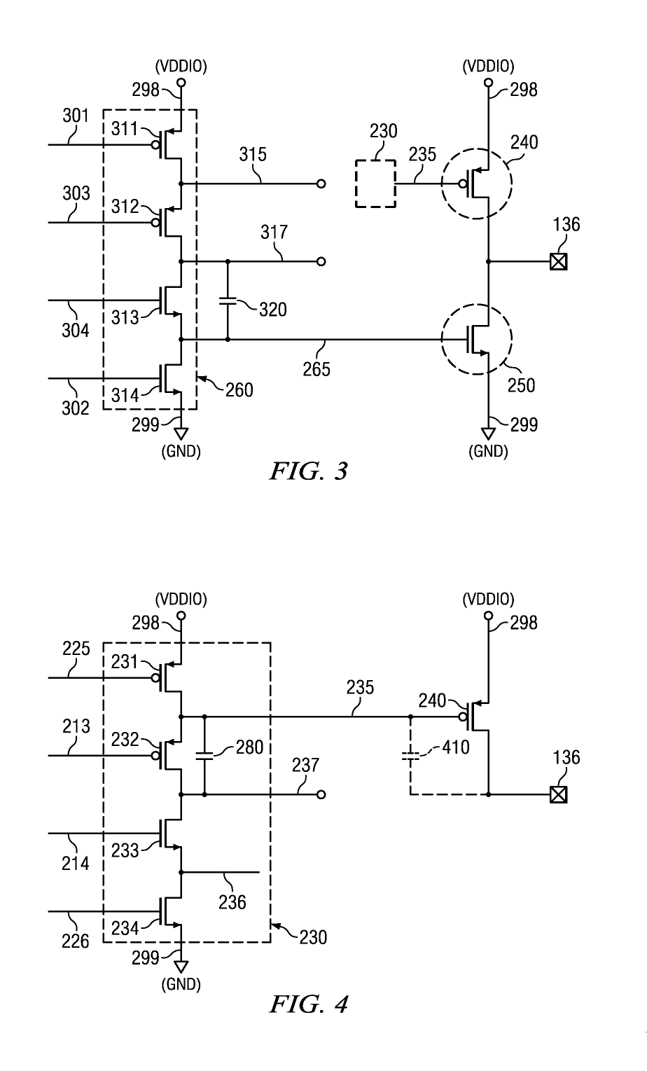

Block 260 as well as pull-up circuit 240 and pull-down circuit 250 are shown in greater detail in FIG. 3. In FIG. 3, block 260 is shown represented by driver circuit 260, which in turn is shown containing PMOS 311 and 312, NMOS 313 and 314, and capacitor 320. Although block 260 is shown as containing only one driver circuit in FIG. 3, multiple driver circuits connected in sequence (such as the series connection of drivers 220 and 230 used to drive pull-up circuit 240) may typically be used. Paths 303 and 304 receive bias voltages equal respectively to bias voltages 213 and 214. Level-shifted signals 301 and 302 are received from level-shifter 210 and deemed to be contained in path 261 of FIG. 2. Capacitor 320 is connected across transistor 313 (i.e., between junction terminal 317 and terminal 265). Signals on paths (or driver nodes) 315 and 265 are also referred to herein as driver signals, and respectively are the logic inverse of signals 301 and 302. Driver signal 265 is connected to, and controls the ON/OFF state of pull-down circuit 250, shown implemented using an NMOS transistor. Pull-up circuit 240 is shown implemented using a PMOS transistor. Driver circuit 260 represents a cascoded inverter.

Although output buffer 130 is described as containing multiple drivers connected in sequence to drive each of pull-up circuit 240 and pull-down circuit 250, in other embodiments, only one driver each may be used. Thus, in such embodiments, driver circuit 220 may not be implemented, and level-shifter 210 provides level-shifted signals 211 and 212 directly to the gate terminals of transistors 231 and 234 of driver circuit 230. Similarly, only one driver circuit may be used to drive pull-down circuit 250.

To illustrate the operation of output buffer 130 with combined reference to FIGS. 2 and 3, assume input signal 123 (Vin) is received as a logic one, and output signal 136 is to be provided as logic one. Level-shifter 210 generates (in response to the logic one received on path 123) logic zero signals on paths 211 and 212. As a result, each of driver signals 225 and 226 is at logic one. Hence, signal 235 is at logic zero thereby switching-ON transistor 240 (FIG. 3). Level-shifter 210 generates signals 301 and 302 such that driver signal 265 is at logic zero. Consequently transistor 250 (FIG. 3) is switched-OFF, and a logic one (approximately equal to VDDIO) is provided as output signal 136. The components and blocks of output buffer 130 operate in a corresponding manner to provide a logic zero on output node 136, when input signal 123 is a logic zero. When output node 136 is to be tri-stated (high impedance), output buffer 130 generates signals to cause both of transistors 240 and 250 to be switched-OFF. Output node 136 may then be used to receive an input signal, which can be processed by corresponding processing circuits, not shown.

The voltage level(s) of a driver signal in output buffer 130 generally determines the characteristics of the signal generated by the component or stage that is controlled by the driver signal. To illustrate, the output impedance (ON-impedance of transistor 240) with which a logic one value of output signal 136 is generated (launched) depends on the voltage level of signal 235 that causes a transition to logic one of output signal 136. Similarly, the ON-impedance of transistor 250 with which a logic zero value of output signal 136 is launched depends on the voltage level of signal 265 that causes a transition to logic zero of output signal 136. An impedance mismatch between the output impedance with which signal 136 is launched may affect the signal quality of output signal 136. Impedance mismatches may lead to signal reflections and degrade the quality of output signal 136. In addition, the rise and/or fall times of output signal 136 may also be rendered large.

The inclusion of a capacitor in a driver circuit (such as circuit 230 and 260) ensures proper output signal quality as described next.

### 2. Improving Output Signal Quality

FIG. 4 shows a portion of output buffer 130. Driver circuit 230 and transistor 240 are shown there. A transition of signal 225 from logic zero to logic one (corresponding to a transition from 0.5*VDDIO volts to VDDIO volts) to cause output signal 136 to transition to logic one causes driver signal 235 to transition from logic one to logic zero (corresponding to a transition from to VDDIO volts to 0.5*VDDIO volts). Ideally, the steady state logic zero voltage level of signal 235 should equal (approximately) 0.5*VDDIO volts.

If capacitor 280 were not connected between nodes 235 and 237, the fall in the voltage level of signal 235 leads to a corresponding reduction in the gate-to-source voltage (Vgs) of transistor 232. As a result, the ON-impedance of transistor 232 increases. Consequently, voltage at node 235 may require an interval of time longer than the time duration of a logic zero or logic one to be generated at node 136 (i.e., one bit duration) to reduce to the desired steady-state level of 0.5*VDDIO. In particular, as the voltage at node 235 starts falling below (0.5*VDDIO+Vtp), Vtp being the threshold voltage of transistor 232, transistor 232 is close to being at cut-off, thereby resulting in the increased time interval noted above.

As voltage at node 235 falls, the voltage at node 136 increases. The rise in voltage at node 136 may be coupled to node 235 due to parasitic gate-to-drain capacitance (indicated as capacitance 410 in FIG. 4) of transistor 240. Further, capacitance 410 may be magnified due to Miller effect. Due to the reasons noted above, signal 235 may not be able to change to the desired steady state level sufficiently quickly. A similar effect occurs at node 265 when signal 265 transitions from logic zero to logic one to cause output signal 136 to transition to logic zero and when capacitor 320 were not connected across transistor 313.

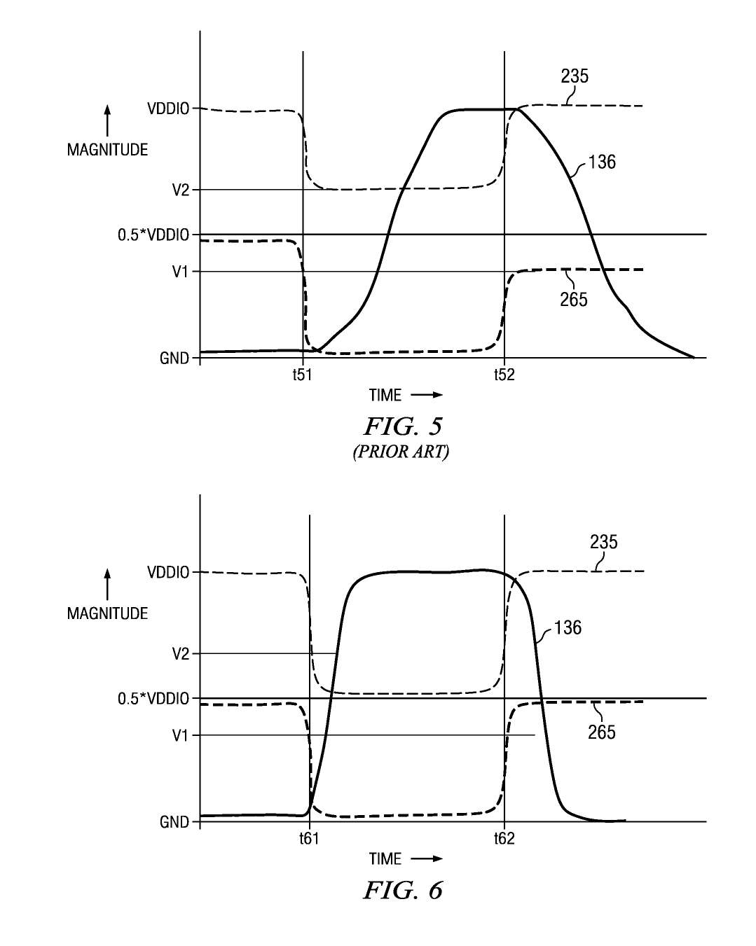

FIG. 5 is a diagram illustrating the waveforms at nodes 235, 136 and 265, as may occur in a prior implementation in which capacitors 280, 320 and 270 are not used or implemented. At time instance t51, signals 235 and 265 are shown transitioning from logic one to logic zero to cause output signal 136 to transition to logic one. However, as shown in FIG. 5 and as noted above, signal 235 does not reach the ideal or desired logic-low voltage level of 0.5*VDDIO by time (or well before) time instance t52 at which signals 235 and 265 again change logic state (transition to logic one in the illustration of FIG. 5. Interval t51 to t52 represents the period of one logic bit (bit-width). Signal 235 has a higher logic-low voltage, shown in FIG. 5 as voltage V2. Since signal 235 does not reach the desired logic-low value (0.5*VDDIO) much earlier than or at least prior to t52, the ON-impedance of pull-up circuit 240 at the launch of the transition of signal 136 from logic zero to logic one is higher than desired.

In particular, the ON-impedance of pull-up circuit 240 in the interval t51-t52 may be different from the impedance of the wired path connecting node/pad 136 to an external component, such as IC 150 (FIG. 1). The wired path may include bond wire 137, pin 138 and PCB trace 139. As a result, the transition to logic one of signal 136 is launched with impedance mismatch between the output impedance of output buffer 130 and impedance of the wired path connected to node 136. As is well-known in the relevant arts, such impedance mismatch may cause reflections of signal 136 at one or more points on the wired path, thereby degrading the quality of signal 136. In addition the rise-time of signal 136 may be prolonged.

A similar effect occurs when output signal 136 is to transition to logic low. As shown in FIG. 5, signals 235 and 265 transition to logic one at time instance t52 to cause signal 136 to transition to logic zero. However, signal 265 does not reach the desired logic-high value. Hence, the ON-impedance of pull-down circuit 250 at launch of the transition of signal 136 from logic one to logic zero may be different from (and higher than) the impedance of the wired path connected to node/pad 136, thereby degrading the quality of signal 136. In addition the fall-time of signal 136 may be prolonged.

It is noted that the output impedance of output buffer 130 at launch of signal transitions of signal 136 may typically need to be of the order of 20 to 50 ohms. The effect of poor signal quality of signal 136, as noted above, may cause inter symbol interference (ISI), with one symbol (or bit) value of signal 136 interfering with a subsequent bit (or bits) of signal 136. Such ISI may lead to errors in correctly interpreting signal 136 (as a logic zero or a logic one) in a receiving component (e.g., IC 150 of FIG. 1).

The drawbacks noted above are addressed in embodiments of the present disclosure by the addition of capacitors in drivers used in output buffer 130. Thus, driver 230 is implemented with capacitor 280 connected between nodes 235 and 237, and driver 260 is implemented with capacitor 320 connected between nodes 317 and 265. The use of capacitors in the drivers enables the transitions of output signal 136 to be launched with lower output impedance, and which more closely matches the impedance of the wired path connecting node 136 to an external component.

To illustrate with reference to FIG. 4, as the signal at node 235 starts falling, capacitor 280 provides a path for node 235 to discharge to the desired logic-low level through transistors 233 and 234. Signal 235 is thus enabled to reach the desired logic-low level. As a result, the ON-impedance of transistor 240 at the time of (or for the duration of) launch of transition of output signal 136 is lower and more closely matches the impedance of the wired path connecting node 136 to an external component, and quality of signal 136 is improved. The implementation of driver 260 with capacitor 320 connected between nodes 317 and 265 similarly improves quality of signal 136 at logic one to logic zero transitions.

FIG. 6 shows waveforms at nodes 235, 265 and 136 of output buffer 130 in an embodiment, with the inclusion of capacitors 280 and 320 in respective drivers 230 and 260, as shown in FIGS. 2 and 3. The time-scale and magnitude-scale in FIG. 6 are respectively assumed to be the same as the time-scale and magnitude-scale in FIG. 5. Thus, for example the time interval t51 to t52 in FIG. 5 equals the time interval t61 to t62 in FIG. 6. At time instance t61, signals 235 and 265 are shown transitioning from logic one to logic zero to cause output signal 136 to transition to logic one. It may be observed from FIG. 6, that signal 235 reaches a desired logic-low level voltage of approximately 0.5*VDDIO (which is lower than the level V2 of FIG. 5 by comparison) much earlier than time instance t62). In general, the inclusion of capacitor 280 enables signal 235 to reach the desired logic-low level sufficiently earlier than a bit-period (t61 to t62) of output 136, and is shown in FIG. 6 as occurring almost instantaneously.

At time instance t62, signals 235 and 265 are shown transitioning from logic zero to logic one to cause output signal 136 to transition to logic zero. Again, it may be observed that signal 265 reaches a desired logic-high level of 0.5*VDDIO sufficiently earlier than a bit-period.

Drivers implemented as described above provide several benefits. One benefit, as already noted above, is minimized signal reflections (of output 136), and therefore better signal quality. Output signal 136, thus generated, may be associated with lesser inter-symbol interference, and thus lesser jitter, and can be more reliably interpreted or decoded at a receiving device. In addition, signal 136 may be associated with shorter rise and/or fall times than in FIG. 5, as may also be observed from a comparison of FIGS. 5 and 6.

Further, the logic-low voltage level of signal 235 can be made lower than 0.5*VDDIO by increasing the capacitance of capacitor 280. Hence, the size of (output stage) transistor 240 can be reduced while maintaining the same output signal quality. Similarly, the logic-high voltage level of signal 265 can be made larger than 0.5*VDDIO by increasing the capacitance of capacitor 320. Hence, the size of (output stage) transistor 250 can also be reduced while maintaining the same output signal quality. Output buffer 130 may thus be implemented with smaller area than otherwise.

Another benefit is that a portion of the current that flows when signal 235 falls from logic one to logic zero can now flow through capacitor 280. Therefore, degradation in transistor 232 due to hot-carrier injection (HCI) is reduced. A similar benefit is obtained in transistor 313 of driver 260. Thus, reliability of output buffer 130 is also improved.

Drivers which generate signals that are provided as inputs to drivers 230 and 260 may also be implemented with capacitors connected across the corresponding nodes. Thus, for example, driver 220 is shown implemented to include capacitor 270 between nodes 225 and 227 (FIG. 2).

Output buffer 130, implemented as described above, may be incorporated in a system/device, as described next.

### 3. Device/System

FIG. 7 is a block diagram of receiver system 700 illustrating an example system in which several embodiments of the present disclosure can be implemented. Receiver system 700, is shown containing antenna 710, analog processor 720, ADC 750, and processing unit 780. Antenna 710 may receive various signals transmitted over a wireless medium. The received signals may be provided to analog processor 720 on path 712 for further processing. Analog processor 720 may perform tasks such as amplification (or attenuation as desired), filtering, frequency conversion, etc., on received signals, and provides the resulting signal on path 725.

ADC 750 converts the analog signal received on path 725 to corresponding digital codes. ADC 750 may contain one or more output buffers (including drivers) such as output buffer 130 implemented according to approaches described above, and may provide the digital codes to processing unit 780 on path 758 for further processing, via such output buffers. Processing unit 780 receives the recovered data to provide various user applications (such as telephone calls, data applications).

It should be appreciated that the specific type of transistors (such as NMOS, PMOS, etc.) noted above are merely by way of illustration. However, alternative embodiments using different configurations and transistors will be apparent to one skilled in the relevant arts by reading the disclosure provided herein. For example, NMOS and PMOS transistors may be interchanged, while also interchanging the connections to power and ground terminals. Accordingly, in the instant application, the power and ground terminals are referred to as reference potentials, the source (emitter) and drain (collector) terminals of transistors (though which a current path is provided when turned on and an open path is provided when turned off) are termed as current terminals, and the gate (base) terminal is termed as a control terminal.

In the illustrations of FIGS. 2, 3 and 4, although terminals/nodes are shown with direct connections to various other terminals, it should be appreciated that additional components (as suited for the specific environment) may also be present in the path, and accordingly the connections may be viewed as being electrically coupled to the same connected terminals.

While various embodiments of the present disclosure have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A driver circuit in an output buffer, the driver circuit comprising:
a first pair of transistors comprising a first transistor and a second transistor coupled in cascode configuration, the first transistor to receive a first level-shifted signal and to generate a first driver signal as a logic inverse of the first level-shifted signal on a first driver node;
a second pair of transistors comprising a third transistor and a fourth transistor coupled in cascode configuration, the fourth transistor to receive a second level-shifted signal and to generate a second driver signal as a logic inverse of the second level-shifted signal on a second driver node, the second pair of transistors being connected to the first pair of transistors at a junction node, the combination of the first pair of transistors and the second pair of transistors forming a cascoded inverter; and
a capacitor coupled across the first driver node and the junction node in parallel with the second transistor,
wherein each of the first level-shifted signal and the second level-shifted signal represents a logic level of an input signal received by the output buffer, and wherein the first driver signal and the second driver signal are each coupled to an output node of the output buffer at which an output signal of the output buffer is generated, the output signal representing the input signal with an increased drive.

2. The driver circuit of claim 1, wherein the capacitor provides a low-impedance path for the first driver signal to change from a value representing one logic level to a value representing another logic level in a time interval shorter than a bit-period of the output signal, the capacitor thereby enabling the first driver signal to reach a DC voltage of lower value within the time interval, the DC voltage representing a logic-low level of the first driver signal,

3. The driver circuit of claim 2, wherein the first level-shifted signal and the second level-shifted signal are generated by a level shifter included in the output buffer, the level shifter to receive the input signal and to generate the first level-shifted signal and the second level-shifted signal in response.

4. The driver circuit of claim 3, wherein the first driver node is coupled to an output stage coupled between the driver circuit and the output node, the output stage comprising a pull-up circuit and a pull-down circuit.

5. The driver circuit of claim 4, wherein another driver circuit is coupled between the driver circuit and the output stage to provide additional buffering for the output signal.

6. The driver circuit of claim 1, wherein each of the first transistor and the second transistor is a P-type MOS transistor, and each of the third transistor and the fourth transistor is an N-type MOS transistor.

7. An integrated circuit (IC), the IC comprising:
a core generating a signal; and
an output buffer to receive the signal as an input signal and to generate an output signal at an output node, the output buffer comprising a driver circuit, the driver circuit comprising:
a first pair of P-type MOS transistors coupled in cascode configuration, a first transistor in the first pair of P-type MOS transistors to receive a first level-shifted signal, the first pair of P-type MOS transistors to generate a first driver signal as a logic inverse of the first level-shifted signal on a first driver node;
a second pair of N-type MOS transistors coupled in cascode configuration, a second transistor in the second pair of N-type MOS transistors to receive a second level-shifted signal, the second pair of N-type MOS transistors to generate a second driver signal as a logic inverse of the second level-shifted signal on a second driver node, the second pair of N-type MOS transistors being connected to the first pair of P-type MOS transistors at a junction node; and
a capacitor coupled across the second driver node and the junction node,
wherein the first level-shifted signal and the second level-shifted signal represent a logic level of the input signal, and wherein the first driver signal and the second driver signal are each coupled to the output node, and
wherein the capacitor provides a low-impedance path for the first driver signal to change from a value representing one logic level to a value representing another logic level in a time interval shorter than a bit-period of the output signal.

8. The IC of claim 7, wherein the output buffer further comprises a level shifter to receive the input signal and to generate the first level-shifted signal and the second level-shifted signal in response.

9. The IC of claim 8, wherein the output buffer further comprises an output transistor coupled to receive the second driver signal, a current terminal of the output transistor being coupled to the output node.

10. The IC of claim 9, wherein another driver circuit is coupled between the driver circuit and the output transistor to provide additional buffering for the output signal.

11. An output buffer to receive an input signal and provide an output signal at an output node, the output buffer comprising a driver circuit, the driver circuit comprising:
a first transistor, a second transistor, a third transistor, a fourth transistor and a capacitor,
wherein, a first current terminal of the first transistor is coupled to a first reference potential, a second current terminal of the first transistor is coupled to a first current terminal of the second transistor, a second current terminal of the second transistor is coupled to a first current terminal of the third transistor, a second current terminal of the third transistor is coupled to a first current terminal of the fourth transistor, and a second current terminal of the fourth transistor is coupled to a second reference potential,
wherein a control terminal of the first transistor receives a first level-shifted signal, a first driver signal being provided as a logic inverse of the first level-shifted signal at the second current terminal of the first transistor,
wherein a control terminal of the fourth transistor receives a second level-shifted signal, a second driver signal being provided as a logic inverse of the second level-shifted signal at the first current terminal of the fourth transistor,
wherein the first level-shifted signal and the second level-shifted signal represent the input signal,
wherein the capacitor is coupled between the first current terminal of the second transistor and the second current terminal of the second transistor, the control terminal of the second transistor receiving a first bias voltage, and the control terminal of the third transistor receiving a second bias voltage,
wherein the first driver signal and the second driver signal are each coupled to the output node at which the output signal is provided.

12. The output buffer of claim 11, further comprising a level shifter to receive the input signal and to generate the first level-shifted signal and the second level-shifted signal.

13. The output buffer of claim 12 further comprising an output transistor coupled to receive the first driver signal, a current terminal of the output transistor being coupled to the output node.

14. The output buffer of claim 13, wherein another driver circuit is coupled between the driver circuit and the output transistor to provide additional buffering for the output signal.
